(19) United States
(12) Patent Application Publication
(10) Pub. No.: US 2008/0178074 A1
(43) Pub. Date: Jul. 24, 2008

(54) DATA PRESENTATION SYSTEM AND METHOD

(76) Inventor: Richard W. Stallings, Plymouth, MI (US)

Correspondence Address: HOLLAND & KNIGHT LLP, 10 ST. JAMES AVENUE, 11th Floor, BOSTON, MA, 02116-3889, US

(21) Appl. No.: 11/625,534

(22) Filed: Jan. 22, 2007

(51) Int. Cl. G06F 17/00; G06F 3/00

(52) U.S. Cl. 715/249; 715/731; 715/255; 715/243

(57) ABSTRACT

A method and computer program product for generating a data file. A selected physical media emulation format is defined, which is chosen from one or more available physical media emulation formats. The data file is formatted in accordance with the selected physical media emulation format, thus generating a formatted data file. The formatted data file is published.

### TECHNICAL FIELD

This disclosure relates to data presentation systems and, more particularly, to data presentation systems that format the data presented to emulate familiar media formats.

### BACKGROUND

Prior to the proliferation of the personal computer, when consuming a document, the reader was able to review the document in accordance with their personal tastes. For example, if the document was a book, the reader may quickly preview the book by e.g., reading the first couple of paragraphs of each chapter of the book. Further, if the document was a magazine, the reader may jump to a specific editorial, or immediately open to the inside back cover of the magazine, or skip right to the classified ads within the magazine.

As the popularity of personal computers increased, many documents began to appear in electronic format (e.g., Microsoft Word™ format or Adobe Acrobat™ format). Unfortunately, when consuming an electronic document, the manner in which the reader may consume the electronic document is typically limited (i.e., when compared to the hardcopy equivalent of the document). For example, if the document is a 30 page document and the user wishes to jump to page 25, the user may be required to scroll through pages 1-24 before arriving at page 25. Further, if the document being consumed is the electronic equivalent of an edge bound magazine, the electronic document will typically not be presented to the reader in a side-by-side format. Accordingly, if the event that e.g., a photograph is included within the magazine that spans two adjacent pages, in order to see the entire photograph, the reader may be required to toggle between e.g., page 13 and page 14.

### SUMMARY OF DISCLOSURE

In a first implementation, a data-presentation method includes generating a data file. A selected physical media emulation format is defined, which is chosen from one or more available physical media emulation formats. The data file is formatted in accordance with the selected physical media emulation format, thus generating a formatted data file. The formatted data file is published.

One or more of the following features may be included. Generating a data file may include authoring a data file. Generating a data file may include importing a data file. The formatted data file may include text-based elements, graphic-based elements, and/or multimedia-based elements. Publishing the formatted data file may include rendering the formatted data file on a display screen. Publishing the formatted data file may include printing the formatted data file on a printing device. Publishing the formatted data file may include posting the formatted data file to a website. Publishing the formatted data file may include storing the formatted data file on a storage device.

The one or more available physical media emulation formats may be chosen from the group consisting of: an edge-bound single page book format, an edge-bound dual page book format; a top-bound single page notepad format; a top-bound dual page notepad format; a scroll format; and a newspaper format. The data file may be a word processor data file. The formatted data file may be modified to include one or more supplemental data items. The one or more supplemental data items may be chosen from the group consisting of: a highlight, an annotation, an underline, and a note.

In another implementation, a computer program product resides on a computer readable medium and has a plurality of instructions stored on it. When executed by a processor, the instructions cause the processor to perform operations including generating a data file. A selected physical media emulation format is defined, which is chosen from one or more available physical media emulation formats. The data file is formatted in accordance with the selected physical media emulation format, thus generating a formatted data file. The formatted data file is published.

One or more of the following features may be included. Generating a data file may include authoring a data file. Generating a data file may include importing a data file. The formatted data file may include text-based elements, graphic-based elements, and/or multimedia-based elements. Publishing the formatted data file may include rendering the formatted data file on a display screen. Publishing the formatted data file may include printing the formatted data file on a printing device. Publishing the formatted data file may include posting the formatted data file to a website. Publishing the formatted data file may include storing the formatted data file on a storage device.

The one or more available physical media emulation formats may be chosen from the group consisting of: an edge-bound single page book format, an edge-bound dual page book format; a top-bound single page notepad format; a top-bound dual page notepad format; a scroll format; and a newspaper format. The data file may be a word processor data file. The formatted data file may be modified to include one or more supplemental data items. The one or more supplemental data items may be chosen from the group consisting of: a highlight, an annotation, an underline, and a note.

In another implementation, a data-presentation method includes defining a selected physical media emulation format chosen from one or more available physical media emulation formats. A data file is formatted in accordance with the selected physical media emulation format, thus generating a formatted data file. The formatted data file is stored on a storage device.

One or more of the following features may be included. The one or more available physical media emulation formats may be chosen from the group consisting of: an edge-bound single page book format, an edge-bound dual page book format; a top-bound single page notepad format; a top-bound dual page notepad format; a scroll format; and a newspaper format. The formatted data file may be modified to include one or more supplemental data items. The one or more supplemental data items may be chosen from the group consisting of: a highlight, an annotation, an underline, and a note.

In another implementation, a computer program product resides on a computer readable medium and has a plurality of instructions stored on it. When executed by a processor, the instructions cause the processor to perform operations including defining a selected physical media emulation format chosen from one or more available physical media emulation formats. A data file is formatted in accordance with the selected physical media emulation format, thus generating a formatted data file. The formatted data file is stored on a storage device.

One or more of the following features may be included. The one or more available physical media emulation formats may be chosen from the group consisting of: an edge-bound single page book format, an edge-bound dual page book format; a top-bound single page notepad format; a top-bound dual page notepad format; a scroll format; and a newspaper format. The formatted data file may be modified to include one or more supplemental data items. The one or more supplemental data items may be chosen from the group consisting of: a highlight, an annotation, an underline, and a note.

The details of one or more implementations is set forth in the accompanying drawings and the description below. Other features and advantages will become apparent from the description, the drawings, and the claims.

### BRIEF DESCRIPTION OF THE DRAWINGS

FIG. 1 is a diagrammatic view of a data presentation process coupled to a distributed computing network;

FIG. 2 is a flowchart of a process executed by the data presentation process of FIG. 1;

FIG. 3 is a diagrammatic view of a user interface screen rendered by the data presentation process of FIG. 1;

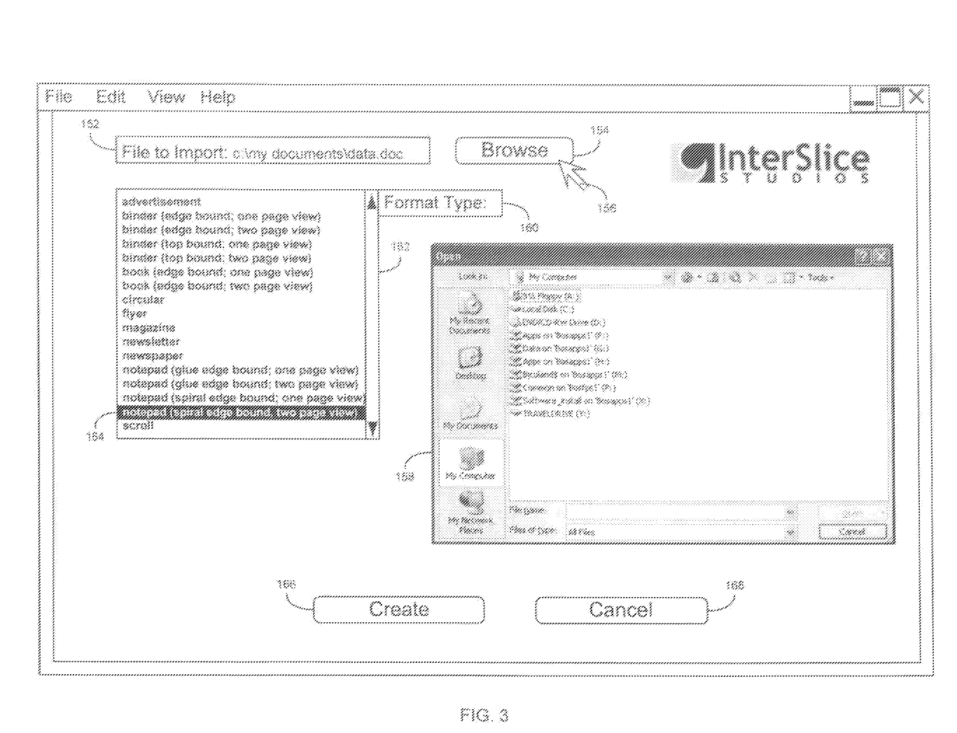

FIG. 4 is a diagrammatic view of a screen rendered by the data presentation process of FIG. 1;

FIG. 5 is a diagrammatic view of a screen rendered by the data presentation process of FIG. 1;

FIG. 6 is a diagrammatic view of a screen rendered by the data presentation process of FIG. 1; and

FIG. 7 is a diagrammatic view of a screen rendered by the data presentation process of FIG. 1.

### DETAILED DESCRIPTION OF THE PREFERRED EMBODIMENTS

### System Overview:

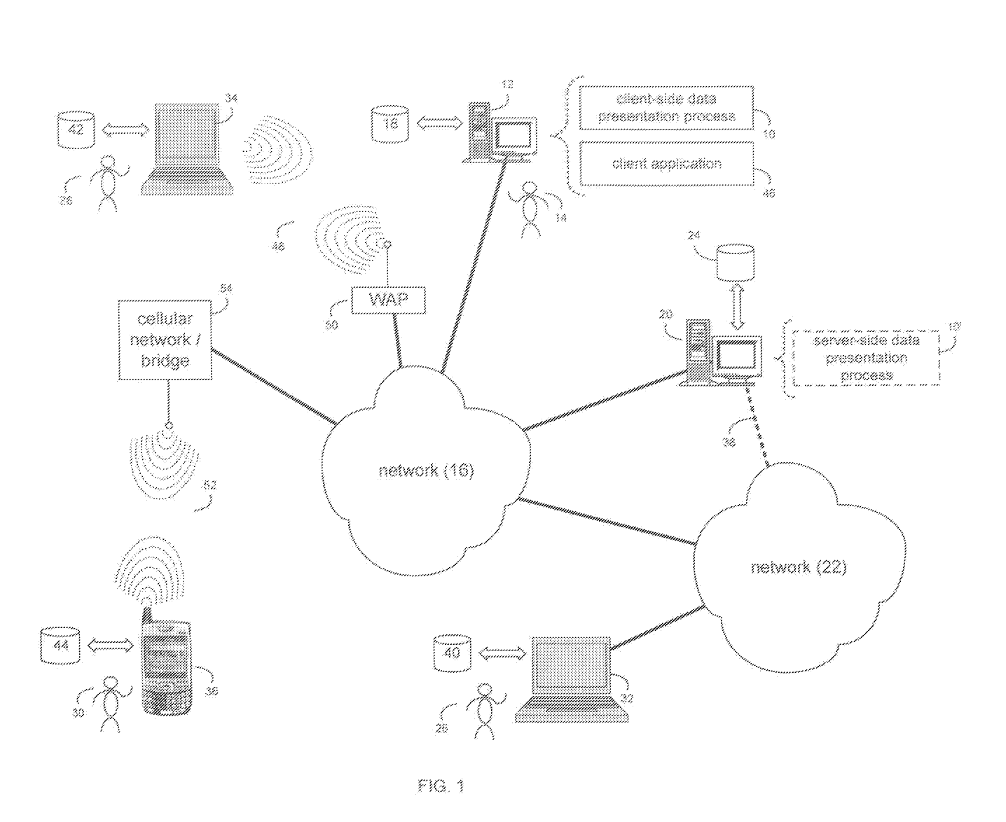

Referring to FIG. 1, there is shown a data presentation process 10 that may reside on and may be executed by a computing device (e.g., client computer 12). Examples of computing devices may include, but are not limited to, personal computers, laptop computers, notebook computers, and personal digital assistants, for example. As will be discussed below in greater detail, data presentation process 10 may allow a user 14 to define a physical media emulation format for an electronic document and format the electronic document in accordance with the selected physical media emulation format.

Data presentation process 10 may be a client-side application that resides on and is executed by e.g., client computer 12, which may be connected to network 16 (e.g., the Internet). The instruction sets and subroutines of data presentation process 10, which may be stored on a storage device 18 coupled to client computer 12, may be executed by one or more processors (not shown) and one or more memory architectures (not shown) incorporated into client computer 12. Storage device 18 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally/alternatively, the above-described data presentation process may be a server-based application, as represented in FIG. 1 by server-side data presentation process 10′ (shown in phantom). Server-side data presentation process 10′ may reside on and be executed by data server 20, which may be coupled to network 16. Examples of data server 20 may include, but are not limited to: a personal computer, a server computer, a series of server computers, a mini computer, and a mainframe computer, for example. Data server 20 may execute a network operating system, examples of which may include but are not limited to: Microsoft Windows XP Server™; Novell Netware™; or Redhat Linux™, for example.

Data server 20 may execute a web server application, examples of which may include but are not limited to: Microsoft IIS™, Novell Webserver™, or Apache Webserver™, that allows for HTTP (i.e., HyperText Transfer Protocol) access to data server 20 via network 16. Network 16 may be coupled to one or more secondary networks (e.g., network 22), examples of which may include but are not limited to: a local area network; a wide area network; or an intranet, for example.

The instruction sets and subroutines of server-side data presentation process 10′, which may be stored on a storage device 24 coupled to data server 20, may be executed by one or more processors (not shown) and one or more memory architectures (not shown) incorporated into data server 20. Storage device 24 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As discussed above, the data presentation process may be a client-side application (e.g., client-side data presentation process 10), a server-side application (e.g., server-side data presentation process 10′), or a hybrid client-side/server-side application (e.g., using portions of both client-side data presentation process 10 and server-side data presentation process 10′). Accordingly, the manner in which the data presentation process is accessed may vary depending on whether the data presentation process is a client-side application, a server-side application, or a hybrid client-side/server-side application.

If a client-side application, users 14, 26, 28, 30 may access the client-side data presentation process (e.g., client-side data presentation process 10) directly through the device on which the client-side data presentation process is executed, namely client computer 12, notebook computer 32, laptop computer 34 and personal digital assistant 36, for example. The instruction sets and subroutines of client-side data presentation process 10, which may be stored on a storage device (e.g., storage device 18, 40, 42, 44) coupled to the computing device (e.g., client computer 12, notebook computer 32, laptop computer 34 and personal digital assistant 36, respectively) executing client-side data presentation process 10, may be executed by one or more processors (not shown) and one or more memory architectures (not shown) incorporated into the computing device executing client-side data presentation process 10. Storage devices 18, 40, 42, 44 may include but are not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Alternatively, if a server-side application, users 14, 26, 28, 30 may access the server-side data presentation process (e.g., server-side data presentation process 10′) through network 16 or through secondary network 22. Data server 20 (i.e., the computer that executes server-side data presentation process 10′) may be coupled to network 16 through secondary network 22, as illustrated with phantom link line 38.

If accessing server-side data presentation process 10′, client computer 12, notebook computer 32, laptop computer 34 and personal digital assistant 36 may each execute a client application (e.g., client application 46) that may interface with server-side data presentation process 10′ and facilitate the bidirectional transfer of data between e.g., client computer 12 and data server 20.

The client application (e.g., client application 46) may be a web browser (e.g., Microsoft Internet Explorer™ and Netscape Navigator™, for example), a stand alone application, or an applet running within another program (e.g., Microsoft Internet Explorer™ and Netscape Navigator™, for example).

Client computer 12, notebook computer 32, laptop computer 34 and personal digital assistant 36 may each execute an operating system, examples of which may include but are not limited to Microsoft Windows™, Microsoft Windows Mobile™, Redhat Linux™, or a custom operating system.

The various computing devices (e.g., client computer 12, notebook computer 32, laptop computer 34 and personal digital assistant 36) may be directly or indirectly coupled to network 16 (or network 22). For example, client computer 12 is shown directly coupled to network 16 via a hardwired network connection, and notebook computer 32 is shown directly coupled to network 22 via a hardwired network connection.

Laptop computer 34 is shown wirelessly coupled to network 16 via wireless communication channel 48 established between laptop computer 34 and wireless access point (i.e., WAP) 50, which is shown directly coupled to network 16. WAP 50 may be, for example, an IEEE 802.11a, 802.11b, 802.11g, Wi-Fi, and/or Bluetooth device that is capable of establishing wireless communication channel 48 between laptop computer 34 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 36 is shown wirelessly coupled to network 16 via wireless communication channel 52 established between personal digital assistant 36 and cellular network/bridge 54, which is shown directly coupled to network 16.

### The Data Presentation Process:

As discussed above, the data presentation process may be a client-side application, a server-side application, or a hybrid client-side/server-side application. Accordingly, the following disclosure is applicable to all variants of the data presentation process.

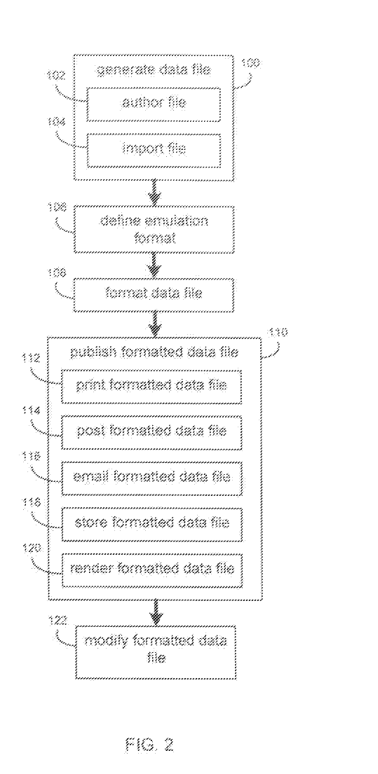

Referring also to FIGS. 2 & 3, data-presentation process 10, 10′ may render user interface screen 150, which allows a user (e.g., user 14) to perform various tasks associated with generating an electronic document. The manner in which user interface screen 150 is presented to the user may vary depending on whether the data presentation process is a client-side application, a server-side application, or a hybrid client-side/server-side application. For example, if a client-side application, user interface 150 may be locally-rendered and presented to the user via e.g., locally-executed, client-side data presentation process 10. Alternatively, if the data presentation process is a server-side application, user interface 150 may be remotely-rendered and presented to the user via e.g., remotely-executed, server-side data presentation process 10′. Further, if a hybrid client-side/server-side data presentation process, user interface 150 may be locally-rendered and presented to the user via e.g., locally-executed, client-side data presentation process 10. However, various templates may be provided to client-side data presentation process 10 by server-side data presentation process 10′ via network 16 (or network 22).

User interface screen 150 may allow the user (e.g., user 14) to generate 100 a data file that may provide all (or a portion thereof) of the content to be included within the electronic document being generated by data presentation process 10, 10′.

Generating 100 a data file may include allowing the user to author 102 the data file or allowing the user to import 104 the data file. For example, user interface 150 may include a “File to Import” field 152 that allows the user to define the location of a data file to be imported 104. The user may manually define the location of the data file by e.g., typing a path and file name (e.g., c:\my documents\data.doc) directly into field 152. Additionally/alternatively, user interface 150 may include a “Browse” button 154, which may be selectable via an onscreen pointer 156 that may be controllable by a pointing device such as a mouse (not shown). Once “Browse” button 154 is selected, a “browsing window” 158 may be rendered by data presentation process 10, 10′. Browsing window 158 may allow the user to “browse” the directory structure of e.g., client computer 12 and define the data file for import 104. An example of a data file type that may be imported 104 may include, but is not limited to, a word processing data file, such as those generated using Microsoft Word™.

As discussed above, data presentation process 10, 10′ may allow the user to author 102 the data file. Therefore, if the user wishes to author 102 (and not import 104) the data file, the user may e.g., leave field 152 blank and, therefore, no data file will be imported 104.

Data presentation process 10, 10′ may allow the user to browse the available physical media emulation formats to define 106 a selected physical media emulation format. User interface 150 may include e.g., a “Format Type” field 160 that allows the user to define 106 a physical media emulation format chosen from a plurality of available physical media emulation formats. When selecting field 160 (using onscreen pointer 156), dropdown menu 162 may appear that defines a plurality of available physical media emulation formats. For example and in this embodiment, dropdown menu 162 is shown to include seventeen available physical media emulation formats, namely: advertisement; binder (edge bound; one page view); binder (edge bound; two page view); binder (top bound; one page view); binder (top bound; two page view); book (edge bound; one page view); book (edge bound; two page view); circular; flyer; magazine; newsletter; newspaper; notepad (glue edge bound; one page view); notepad (glue edge bound; two page view); notepad (spiral edge bound; one page view); notepad (spiral edge bound; two page view); and scroll. While this list is intended to be illustrative, it is not intended to be exhaustive. Accordingly, other physical media emulation formats are considered to be within the scope of this disclosure.

Assume that, after reviewing dropdown menu 162, user 12 would like the electronic document that they are creating (using data presentation process 10, 10′) to resemble a spiral bound notebook. Additionally, assume that user 12 would like the notebook to be edge bound (as opposed to top bound) and provide the consumer of the electronic document with a two page (i.e., side-by-side) view so that the electronic document produced by data presentation process 10, 10′ emulates the look and feel of a hardcopy spiral bound notebook. Accordingly, user 12 may select (using onscreen pointer 156) the “notepad (spiral edge bound, two page view)” physical media emulation format 164 from the plurality of available physical media emulation formats defined within dropdown menu 162.

Once the physical media emulation format is defined and (if desired) the file to be imported is defined, the user may select (using onscreen pointer 156) “Create” button 166. Alternatively, user 14 may select “Cancel” button 168, which may e.g., terminate data presentation process 10, 10′ or clear fields 152, 160.

If “Create” button 166 is selected, data presentation process 10, 10′ may format 108 the data file in accordance with the selected physical media emulation format, thus generating a formatted data file. As discussed above, in the event that no data file is selected for import, the data file being formatted is an empty data file. Accordingly and in this scenario, user 14 may be presented with an empty electronic document (i.e., an electronic document that contains no content but is formatted in accordance with the selected physical media emulation format). Assuming that user selected a data file for import (e.g., c:\my documents\data.doc), upon selecting “Create” button 166, data presentation process 10, 10′ may generate a formatted data file.

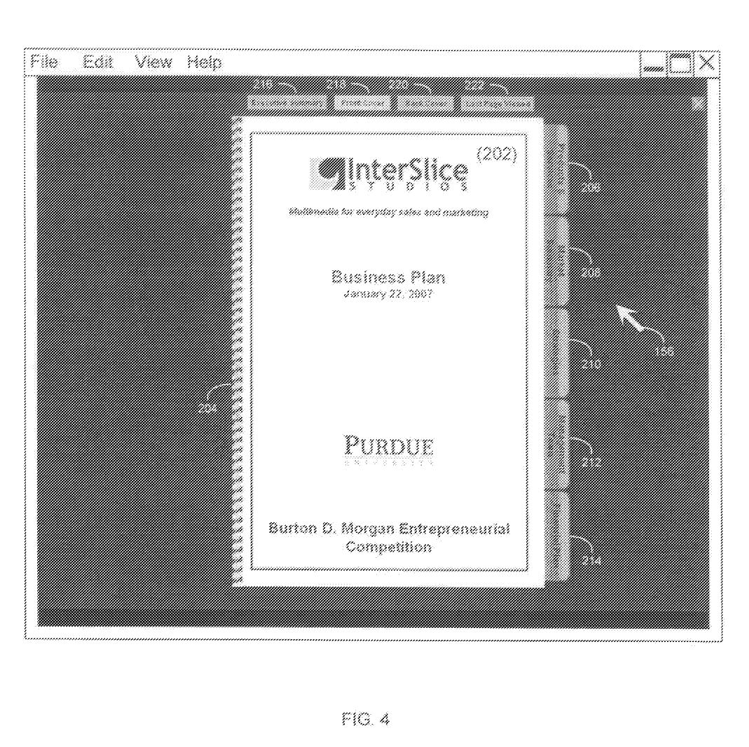

Referring also to FIG. 4, the formatted data file 200 generated by data presentation process 10, 10′ may emulate the look and feel of a physical document. For example and in this embodiment, formatted data file 200 is shown to include e.g., a front cover 202, a spiral edge binding 204, and a plurality of tabs 206, 208, 210, 212, 214. Formatted data file 200 may include additional features that facilitate easier navigation of formatted data file 200, such as a plurality of buttons 216, 218, 220, 222.

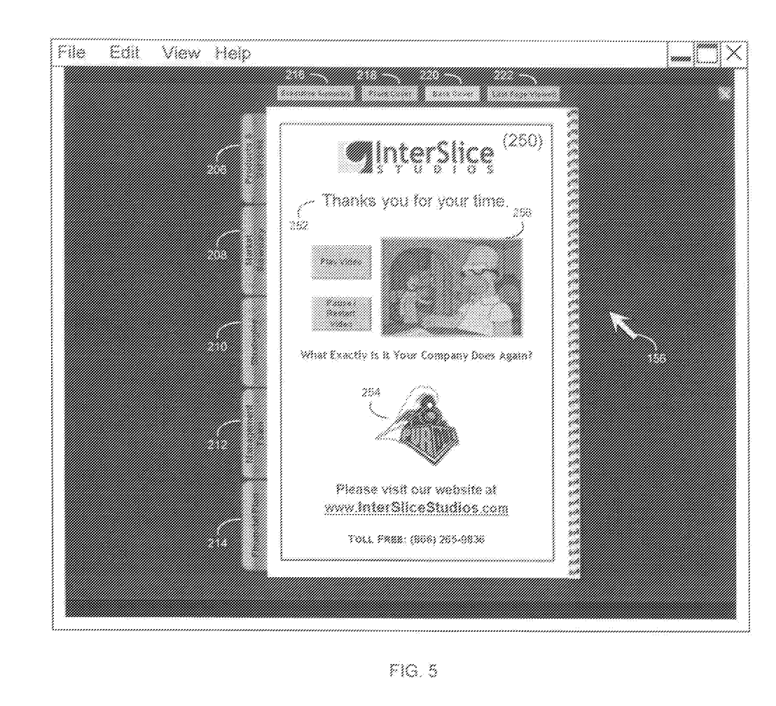

User 14 may navigate formatted data file 200 using onscreen pointer 156. For example, assume that (using onscreen pointer 156), user 14 selects button 220 (i.e., the “back cover” button). Referring also to FIG. 5, data presentation process 10, 10′ may render the back cover 250 of formatted data file 200. As this is the back cover 250 of formatted date file 200, tabs 206, 208, 210, 212, 214 are now positioned on the left side of formatted data file 200. As is shown in FIG. 5, formatted data file 200 may include various data elements, such as text-based elements (e.g., “Thank you for your time” text 252), graphic-based elements (e.g., “Purdue” logo 254), and/or multimedia-based elements (e.g., “The Simpsons”™ audio/video clip 256).

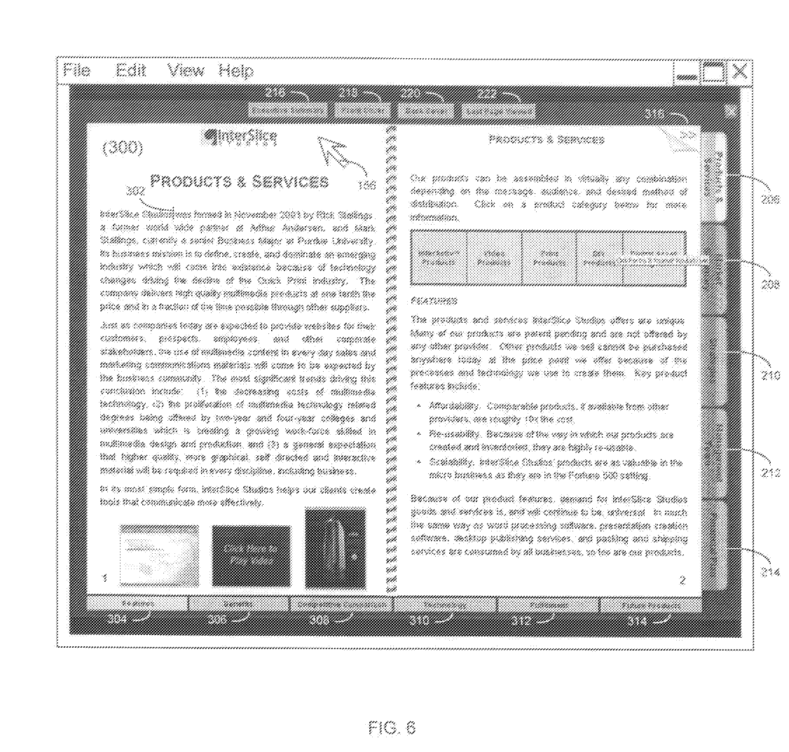

By selecting one or more of tabs 206, 208, 210, 212, 214, user 14 may consume the content included within formatted data file 200 in a manner of their choosing. For example and referring also to FIG. 6, by selecting tab 206 (i.e., the “Products and Services” tab), data presentation process 10, 10′ may render the “Products & Services” portion 300 of formatted data file 200. As user 14 imported 104 a data file, formatted data file 200 includes content. In the event that user 14 did not import 104 a data file and (instead) chose to author 102 their own data file, formatted data file 200 would be blank (i.e., would not include any content). User 14 may author 102 various portions of formatted data file 200 in a manner similar to the way in which a word processor application is used to author a traditional “word processor” data file. For example, user 14 may position cursor 302 (using onscreen pointer 156) within the appropriate section of formatted data file 200 and make edits/add content/delete content. Data presentation system 10, 10′ may include traditional “word processor” functionality, examples of which may include, but are not limited to, spell checking and text wrapping.

If the portion of formatted data file 200 being rendered includes multiple sections, a plurality of buttons 304, 306, 308, 310, 312, 314 may be rendered (by data presentation process 10, 10′) that allow user 12 to navigate between the various sections of e.g., the “Products & Services” portion 300 of formatted data file 200. Additionally, formatted data file 200 may include one or more page change buttons (e.g., arrow button 316) that allows user 14 to “turn” the page of formatted data file 200. As, in this example, the “left-side” page of the “Products & Services” portion 300 is the first page, there is only one page change button. In the event that the “left-side” page was not the first page of portion 300, a “left” pointing page change button may be included within formatted data file 200.

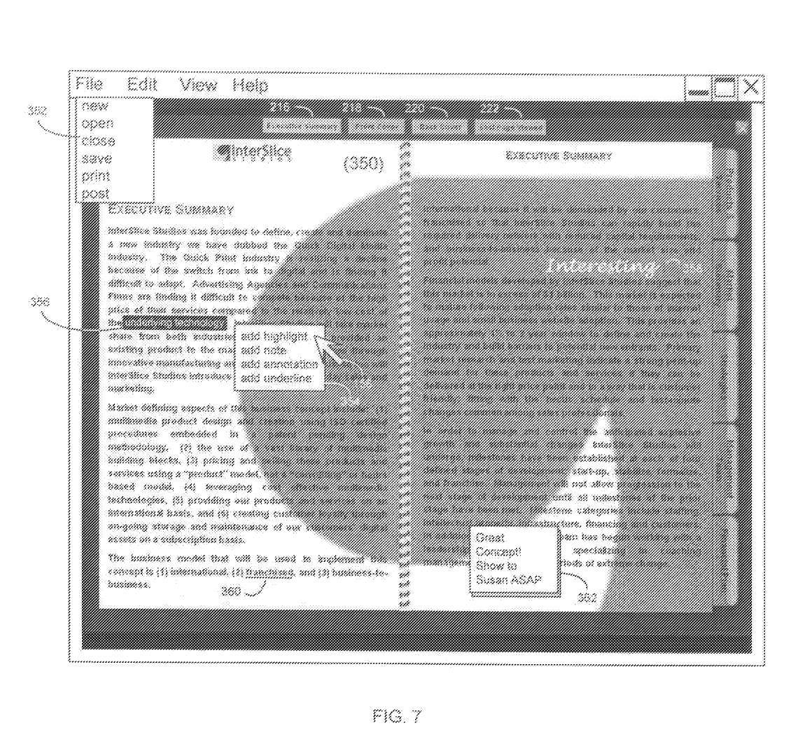

Buttons 216, 218, 220, 222 may provide functionality that concerns features other than navigation. For example and referring also to FIG. 7, by selecting button 216 (i.e., the “Executive Summary” button), data presentation process 10, 10′ may render an executive summary 350 of formatted data file 200. Further, “Last Page Viewed” button 222 may allow the reader to jump backwards to the last page (within formatted data file 200) that the reader viewed.

Data presentation process 10, 10′ may facilitate the publication of formatted data file 200 (and therefore the generation of an electronic document). The user (e.g., user 14) may choose to publish 110 formatted date file 200 in various ways. For example, via drop down menu 352 (selectable via onscreen pointer 156), formatted data file 200 may printed 112 on a printing device (not shown). Further, formatted data file 200 may be posted 114 to a remote server (e.g., data server 20) for viewing/downloading by third parties. Additionally, formatted data file 200 may be emailed 116 (via e.g. an SMTP server, not shown) to third parties for review. Further, formatted data file 200 may be stored 118 on a storage device (e.g., local storage device 18 or remote storage device 24) for subsequent retrieval/distribution. When storing 118 formatted data file 200 on the storage device, data presentation system 10, 10′ may store the file in a plurality of formats, examples of which may include but are not limited to: Microsoft PowerPoint™ format, Adobe Flash™ format, and Java™ format. Additionally, formatted date file 200 may be rendered 120 on a display screen (not shown) coupled to e.g., client computer 12.

Data presentation system 10, 10′ may allow the consumer of formatted data file 200 (i.e., the electronic document) to modify 122 formatted data file 200 to include one or more supplemental data items, examples of which may include but are not limited to a highlight, an annotation, an underline, and a note. The consumer of formatted data file 200 may include user 14 (e.g., the author of formatted data file 200) or third party readers of formatted data file. For example, suppose upon reading formatted data file 200, user 14 wishes to highlight the words “underlying technology” included within the first paragraph of executive summary 350. Using onscreen pointer 156, user 14 may select the words to be highlighted and “right click” the mouse (not shown), which may result in data presentation process 10, 10′ rendering action menu 354. User 14 may select (using onscreen pointer 156) from various options included within action menu 354 that allow the user to: add highlight 356 to formatted data file 200; add annotation 358 to formatted data file 200; add underline 360 to formatted data file 200; and add note 362 to formatted data file 200.

While data presentation process 10, 10′ is defined above as allowing the user to select a physical media emulation format from a plurality of available physical media emulation formats, other configurations are possible and are considered to be within the scope of this disclosure. For example, assume that only one type of physical media emulation format was available (e.g., “notepad (spiral edge bound, two page view)” physical media emulation format), data presentation process 10, 10′ may automatically define 106 the physical media emulation format as “notepad (spiral edge bound, two page view)”, since that is the only physical media emulation format available. As such, “Format Type” field 160 may not be included within user interface 150.

A number of implementations have been described. Nevertheless, it will be understood that various modifications may be made. Accordingly, other implementations are within the scope of the following claims.

What is claimed is:

1. A data-presentation method comprising:
generating a data file;
defining a selected physical media emulation format chosen from one or more available physical media emulation formats;
formatting the data file in accordance with the selected physical media emulation format, thus generating a formatted data file; and
publishing the formatted data file.

2. The method of claim 1 wherein generating a data file includes authoring a data file.

3. The method of claim 1 wherein generating a data file includes importing a data file.

4. The method of claim 1 wherein the formatted data file includes text-based elements.

5. The method of claim 1 wherein the formatted data file includes graphic-based elements.

6. The method of claim 1 wherein the formatted data file includes multimedia-based elements.

7. The method of claim 1 wherein publishing the formatted data file includes rendering the formatted data file on a display screen.

8. The method of claim 1 wherein publishing the formatted data file includes printing the formatted data file on a printing device.

9. The method of claim 1 wherein publishing the formatted data file includes posting the formatted data file to a website.

10. The method of claim 1 wherein publishing the formatted data file includes storing the formatted data file on a storage device.

11. The method of claim 1 wherein the one or more available physical media emulation formats is chosen from the group consisting of: an edge-bound single page book format, an edge-bound dual page book format; a top-bound single page notepad format; a top-bound dual page notepad format; a scroll format; and a newspaper format.

12. The method of claim 1 wherein the data file is a word processor data file.

13. The method of claim 1 further comprising:
modifying the formatted data file to include one or more supplemental data items.

14. The method of claim 13 wherein the one or more supplemental data items is chosen from the group consisting of: a highlight, an annotation, an underline, and a note.

15. A computer program product residing on a computer readable medium having a plurality of instructions stored thereon that, when executed by a processor, cause the processor to perform operations comprising:
generating a data file;
defining a selected physical media emulation format chosen from one or more available physical media emulation formats;
formatting the data file in accordance with the selected physical media emulation format, thus generating a formatted data file; and
publishing the formatted data file.

16. The computer program product of claim 15 wherein the instructions for generating a data file include instructions for authoring a data file.

17. The computer program product of claim 15 wherein the instructions for generating a data file include instructions for importing a data file.

18. The computer program product of claim 15 wherein the formatted data file includes text-based elements.

19. The computer program product of claim 15 wherein the formatted data file includes graphic-based elements.

20. The computer program product of claim 15 wherein the formatted data file includes multimedia-based elements.

21. The computer program product of claim 15 wherein the instructions for publishing the formatted data file include instructions for rendering the formatted data file on a display screen.

22. The computer program product of claim 15 wherein the instructions for publishing the formatted data file include instructions for printing the formatted data file on a printing device.

23. The computer program product of claim 15 wherein the instructions for publishing the formatted data file include instructions for posting the formatted data file to a website.

24. The computer program product of claim 15 wherein the instructions for publishing the formatted data file include instructions for storing the formatted data file on a storage device.

25. The computer program product of claim 15 wherein the one or more available physical media emulation formats is chosen from the group consisting of: an edge-bound single page book format, an edge-bound dual page book format; a top-bound single page notepad format; a top-bound dual page notepad format; a scroll format; and a newspaper format.

26. The computer program product of claim 15 wherein the data file is a word processor data file.

27. The computer program product of claim 15 further comprising instructions for:
modifying the formatted data file to include one or more supplemental data items.

28. The computer program product of claim 27 wherein the one or more supplemental data items is chosen from the group consisting of: a highlight, an annotation, an underline, and a note.

29. A data-presentation method comprising:
defining a selected physical media emulation format chosen from one or more available physical media emulation formats;
formatting a data file in accordance with the selected physical media emulation format, thus generating a formatted data file; and
storing the formatted data file on a storage device.

30. The method of claim 29 wherein the one or more available physical media emulation formats is chosen from the group consisting of: an edge-bound single page book format, an edge-bound dual page book format; a top-bound single page notepad format; a top-bound dual page notepad format; a scroll format; and a newspaper format.

31. The method of claim 29 further comprising:
modifying the formatted data file to include one or more supplemental data items.

32. The method of claim 31 wherein the one or more supplemental data items is chosen from the group consisting of: a highlight, an annotation, an underline, and a note.

33. A computer program product residing on a computer readable medium having a plurality of instructions stored thereon that, when executed by a processor, cause the processor to perform operations comprising:
defining a selected physical media emulation format chosen from one or more available physical media emulation formats;
formatting a data file in accordance with the selected physical media emulation format, thus generating a formatted data file; and
storing the formatted data file on a storage device.

34. The computer program product of claim 29 wherein the one or more available physical media emulation formats is chosen from the group consisting of: an edge-bound single page book format, an edge-bound dual page book format; a top-bound single page notepad format; a top-bound dual page notepad format; a scroll format; and a newspaper format.

35. The computer program product of claim 29 further comprising instructions for:
modifying the formatted data file to include one or more supplemental data items.

36. The computer program product of claim 31 wherein the one or more supplemental data items is chosen from the group consisting of: a highlight, an annotation, an underline, and a note.
